(19) United States
(12) Patent Application Publication
(10) Pub. No.: US 2026/0085793 A1
(43) Pub. Date: Mar. 26, 2026

(54) HYDROGEN SUPPLY SYSTEM

(71) Applicants: Hyundai Motor Company, Seoul (KR); Kia Corporation, Seoul (KR)

(72) Inventors: Hoyoung JEONG, Hwaseong-Si (KR); Hochan AN, Hwaseong-Si (KR); Narae YOON, Hwaseong-Si (KR); Yeon Ho KIM, Hwaseong-Si (KR); Pyung Soon KIM, Hwaseong-Si (KR); Ji-Hoon JANG, Hwaseong-Si (KR); Jeawan KIM, Hwaseong-Si (KR); Gwi Taek KIM, Hwaseong-Si (KR); Hanjin KIM, Hwaseong-Si (KR); Man Hee PARK, Hwaseong-Si (KR); Yeong Jun KIM, Hwaseong-Si (KR); Jae Yeon KIM, Hwaseong-Si (KR); Jihye PARK, Hwaseong-Si (KR)

(73) Assignees: Hyundai Motor Company, Seoul (KR); Kia Corporation, Seoul (KR)

(21) Appl. No.: 19/226,664

(22) Filed: Jun. 3, 2025

(30) Foreign Application Priority Data
Sep. 24, 2024 (KR) 10-2024-0129168

(51) Int. Cl. F17C 11/00

(52) U.S. Cl. CPC F17C 11/005; F17C 2221/012; F17C 2227/0355; F17C 2227/0388; F17C 2265/065

(57) ABSTRACT

A hydrogen supply system may include a first refrigerant circuit including a first compressor, a first heat-exchanger, a first expansion valve, and a second heat-exchanger sequentially disposed on a first refrigerant line, a second refrigerant circuit including a second compressor, a third heat-exchanger, a second expansion valve, and the first heat-exchanger sequentially disposed on a second refrigerant line, a third refrigerant circuit including a third compressor, a fourth heat-exchanger, a third expansion valve, and a fifth heat-exchanger sequentially disposed on a third refrigerant line, a first coolant circuit including a plurality of hydrogen compression tanks disposed on a first coolant line along which a coolant heat-exchanged with the refrigerant circulating the second refrigerant circuit circulates, and a second coolant circuit including the plurality of hydrogen compression tanks disposed on a second coolant line along which the coolant heat-exchanged with the refrigerant circulating the third refrigerant circuit circulates.

### CROSS-REFERENCE TO RELATED APPLICATION

The present application claims priority to and the benefit of Korean Patent Application No. 10-2024-0129168 filed with the Korean Intellectual Property Office on Sep. 24, 2024, the entire contents of which is incorporated herein by reference.

### BACKGROUND OF THE INVENTION

### Field of the Present Disclosure

The present disclosure relates to a hydrogen supply system, and more particularly, the present disclosure relates to a hydrogen supply system configured for storing and compressing hydrogen gas by using metal hydride.

### Description of the Related Art

Recently, in accordance with a continuous increase in interest in energy efficiency and an environmental pollution problem, the development of an environment-friendly vehicle capable of substantially substituting for an internal combustion engine vehicle is required.

The environment-friendly vehicle is classified into an electric vehicle driven using a fuel cell or electricity as a power source and a hybrid vehicle driven using an engine and an electrical battery.

Among them, a hydrogen vehicle is equipped with a cartridge storing hydrogen gas, and generates power required for driving the vehicle by combusting the hydrogen stored in the cartridge.

When the hydrogen gas is consumed while the hydrogen vehicle is driving, hydrogen gas may be refilled into the cartridge at a hydrogen charging station. Conventionally, electric compressors were used to charge hydrogen gas into the cartridge at hydrogen charging stations.

However, when charging hydrogen gas into the cartridge by using an electric compressor, there was a problem that a lot of electrical energy was consumed and maintenance costs increased.

The matters described in the description of the related art are disposed to enhance the understanding of the background of the disclosure, and may include matters that are not already known to those skilled in the art to which the present technology belongs.

### SUMMARY OF THE INVENTION

The present disclosure attempts to provide a hydrogen supply system configured for decreasing electrical energy consumption to decrease the maintenance cost.

A hydrogen supply system may include a first refrigerant circuit including a first compressor, a first heat-exchanger, a first expansion valve, and a second heat-exchanger sequentially disposed on a first refrigerant line along which a refrigerant circulates, a second refrigerant circuit including a second compressor, a third heat-exchanger, a second expansion valve, and the first heat-exchanger sequentially disposed on a second refrigerant line along which the refrigerant circulates, a third refrigerant circuit including a third compressor, a fourth heat-exchanger, a third expansion valve, and a fifth heat-exchanger sequentially disposed on a third refrigerant line along which the refrigerant circulates, a first coolant circuit including a plurality of hydrogen compression tanks disposed on a first coolant line along which a coolant heat-exchanged with the refrigerant circulating the second refrigerant circuit circulates, and a second coolant circuit including the plurality of hydrogen compression tanks disposed on a second coolant line along which the coolant heat-exchanged with the refrigerant circulating the third refrigerant circuit circulates, where the hydrogen gas is stored and compressed through a metal stored in each hydrogen compression tank depending on a temperature change of the coolant circulating the first coolant circuit and the second coolant circuit.

The refrigerant circulating the first refrigerant line and the refrigerant circulating the second refrigerant line may be heat-exchanged in the first heat-exchanger.

The first coolant circuit may include a plurality of first coolant lines, and the coolant circulating the first coolant line may be heat-exchanged with the refrigerant circulating the second refrigerant line in the third heat-exchanger.

The second coolant circuit may include a plurality of second coolant lines, and the coolant circulating the second coolant line may be heat-exchanged with the refrigerant circulating the third refrigerant line in the fifth heat-exchanger.

The hydrogen supply system may further include a sixth heat-exchanger connected to the second heat-exchanger and configured to heat-exchange a heat absorbed by the refrigerant while being vaporized at the second heat-exchanger with an external air.

The hydrogen supply system may further include a seventh heat-exchanger connected to the fourth heat-exchanger and configured to heat-exchange a heat generated while the refrigerant is condensed at the fourth heat-exchanger with an external air.

The hydrogen compression tank may include a tank body accommodating metal hydride, a coolant inlet line selectively and fluidically connected to the first coolant line and the second coolant line, a coolant discharge line selectively and fluidically connected to the first coolant line and the second coolant line, a hydrogen inlet line disposed with a first hydrogen valve to selectively supply the hydrogen gas to the tank body, and a hydrogen discharge line on which a second hydrogen valve is disposed so that the hydrogen gas desorbed from the metal hydride is selectively discharged.

The hydrogen supply system may further include a tank valve disposed on the tank body and configured to selectively open or close the first coolant line and the second coolant line.

The tank valve may be a three-way valve.

Depending on an operation of the first hydrogen valve, the second hydrogen valve, and the tank valve, the hydrogen supply system operates in one mode among a cooling mode for cooling the metal of the hydrogen compression tank, an adsorption mode for adsorbing the hydrogen gas on the metal in the hydrogen compression tank, a heating mode for heating the metal hydride in the hydrogen compression tank, and a discharge mode for discharging the hydrogen gas compressed at the hydrogen compression tank.

In the cooling mode, the tank valve may block the first coolant line and opens the second coolant line so that the coolant circulating the second coolant line cools the hydrogen compression tank, and the first hydrogen valve and the second hydrogen valve may be blocked.

In the adsorption mode, the tank valve may block the first coolant line and opens the second coolant line so that the coolant circulating the second coolant line cools the hydrogen compression tank, the first hydrogen valve may be opened, and the second hydrogen valve may be blocked,

In the heating mode, the tank valve may open the first coolant line and blocks the second coolant line so that the coolant circulating the first coolant line heats the hydrogen compression tank, and the first hydrogen valve and the second hydrogen valve may be blocked.

In the discharge mode, the tank valve may open the first coolant line and blocks the second coolant line so that the coolant circulating the first coolant line heats the hydrogen compression tank, the first hydrogen valve may be blocked, and the second hydrogen valve may be opened.

According to an exemplary embodiment of the present disclosure, by storing and compressing the hydrogen gas depending on the temperature change of the metal hydride, the electrical energy consumption may be decreased and the maintenance cost may be reduced.

Other effects which may be obtained or are predicted by an exemplary embodiment of the present disclosure will be explicitly or implicitly described in a detailed description of the present disclosure. That is, various effects that are predicted according to an exemplary embodiment will be described in the following detailed description.

### BRIEF DESCRIPTION OF THE DRAWINGS

These drawings are for reference in describing an exemplary embodiment of the present disclosure, and the technical spirit of the present disclosure should not be construed as being limited to the accompanying drawings.

FIG. 1 is a schematic view showing a configuration of a hydrogen charging station to which a hydrogen supply system according to an exemplary embodiment of the present disclosure is applied.

FIG. 2 is a block diagram showing a configuration of a hydrogen supply system according to an exemplary embodiment of the present disclosure.

FIG. 3 is a schematic view showing a configuration of a hydrogen compression tank according to an exemplary embodiment of the present disclosure.

FIG. 4, FIG. 5 and FIG. 6 are drawings for explaining a cooling mode and an adsorption mode of a hydrogen supply system according to an exemplary embodiment of the present disclosure.

FIG. 7, FIG. 8 and FIG. 9 are drawings for explaining a heating mode and a discharge mode of a hydrogen supply system according to an exemplary embodiment of the present disclosure.

It should be understood that the above-referenced drawings are not necessarily to scale, presenting a somewhat simplified representation of various exemplary features illustrative of the basic principles of the disclosure. The predetermined design features of the present disclosure, including, for example, predetermined dimensions, orientations, locations, and shapes, will be determined in portion by the particularly intended application and use environment.

### DETAILED DESCRIPTION OF THE EMBODIMENTS

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprises” and/or “comprising,” when used in the present specification, specify the presence of stated features, integers, steps, operations, elements, and/or components, but do not preclude the presence or addition of one or more other features, integers, steps, operations, elements, components, and/or groups thereof. As used herein, the term “and/or” includes any one or all combinations of one or more related items.

The present disclosure will be described more fully hereinafter with reference to the accompanying drawings, in which exemplary embodiments of the disclosure are illustrated. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

Furthermore, the size and thickness of each configuration shown in the drawings are arbitrarily shown for understanding and ease of description, but the present disclosure is not limited thereto, and the thickness of layers, films, panels, regions, etc., are exaggerated for clarity.

Suffixes, “module” and/or “unit” for a constituent element used for the description below are given or mixed in consideration of only easiness of the writing of the specification, and the suffix itself does not have a discriminated meaning or role.

Furthermore, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted.

Furthermore, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including ordinal numbers such as first, second, and the like will be used only to describe various components, and are not interpreted as limiting these components.

As used herein, the singular forms “a”, “an” and “the” are intended to include the plural forms as well, unless the context clearly indicates otherwise.

The terms are only used to differentiate one component from others.

First, a hydrogen charging station to which a hydrogen supply system according to an exemplary embodiment of the present disclosure is applied will be described in detail.

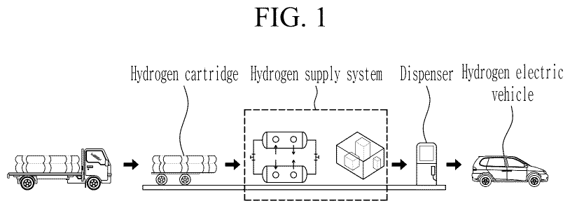

FIG. 1 is a schematic view showing a configuration of a hydrogen charging station to which a hydrogen supply system according to an exemplary embodiment of the present disclosure is applied.

First, referring to FIG. 1, a hydrogen charging station to which a hydrogen supply system according to an exemplary embodiment of the present disclosure is applied will be described in detail.

A hydrogen supply system according to an exemplary embodiment of the present disclosure may be applied to a hydrogen charging station configured to charge the hydrogen gas.

A hydrogen supply system according to an exemplary embodiment of the present disclosure may store or compress the hydrogen gas by using the principle that hydrogen is adsorbed on the metal or hydrogen is desorbed from the metal hydride (MH) depending on the temperature change.

For example, when a metal is cooled, hydrogen molecules may be adsorbed onto metal molecules, and the hydrogen gas may be stored in a container including the metal hydride. To the contrary, when the metal hydride is heated, hydrogen molecules adsorbed on the metal hydride may be desorbed, and the hydrogen gas may be compressed in a container including the metal hydride.

By utilizing such a principle, a hydrogen supply system according to an exemplary embodiment of the present disclosure may be applied to a hydrogen charging station. For example, when a hydrogen cartridge is loaded onto a tube trailer and enters a hydrogen charging station, the hydrogen charged inside hydrogen cartridge may be supplied to the hydrogen supply system, and may cool the metal inside the hydrogen supply system so that the hydrogen may be stored in a form of metal hydride. Thereafter, when the metal hydride is heated so that hydrogen is desorbed from the metal hydride and the pressure increases, the hydrogen gas may be charged into the hydrogen electric vehicle, via a dispenser.

Hereinafter, a hydrogen supply system according to an exemplary embodiment of the present disclosure will be described in detail with reference to the drawings.

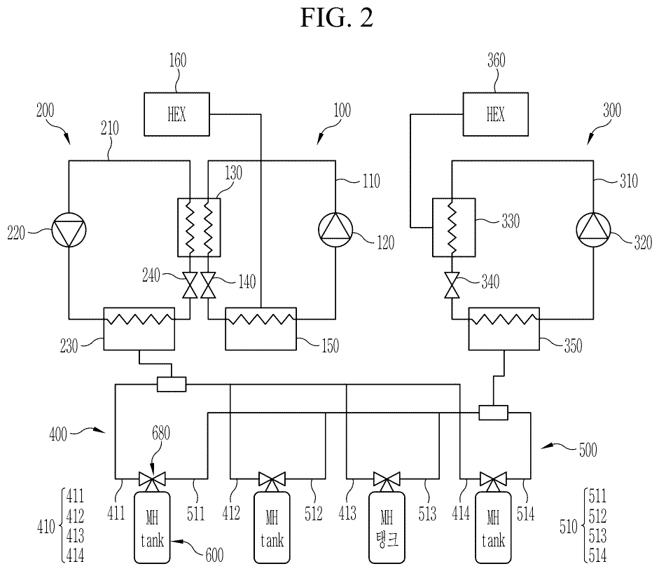

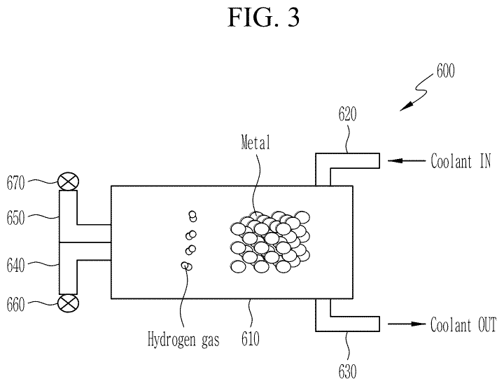

FIG. 2 is a block diagram showing a configuration of a hydrogen supply system according to an exemplary embodiment of the present disclosure. Furthermore, FIG. 3 is a schematic view showing a configuration of a hydrogen compression tank according to an exemplary embodiment of the present disclosure.

As shown in FIG. 2, a hydrogen supply system according to an exemplary embodiment of the present disclosure may include a first refrigerant circuit 100 in which the refrigerant circulates, a second refrigerant circuit 200 in which the refrigerant circulates, a third refrigerant circuit 300 in which the refrigerant circulates, a first coolant circuit 400 in which a coolant heat-exchanging with the refrigerant circulating the second refrigerant circuit 200 circulates, and a second coolant circuit 500 in which the coolant heat-exchanging with the refrigerant circulating the third refrigerant circuit 300 circulates.

A hydrogen supply system according to an exemplary embodiment of the present disclosure may store and compress the hydrogen gas through a metal stored in a hydrogen compression tank 600 depending on a temperature change of the coolant circulating the first coolant circuit 400 and the second coolant circuit 500.

The first refrigerant circuit 100 may include a first refrigerant line 110 along which the refrigerant circulates, and include a first compressor 120, a first heat-exchanger 130, a first expansion valve 140, and a second heat-exchanger 150 sequentially disposed on the first refrigerant line 110. The first compressor 120, the first heat-exchanger 130, the first expansion valve 140, and the second heat-exchanger 150 may be sequentially disposed on the first refrigerant line 110 along the flow direction of the refrigerant.

The second refrigerant circuit 200 may include a second refrigerant line 210 along which the refrigerant circulates, and include a second compressor 220, a third heat-exchanger 230, a second expansion valve 240, and the first heat-exchanger 130 sequentially disposed on and the second refrigerant line 210. The second compressor 220, the third heat-exchanger 230, the second expansion valve 240, and the first heat-exchanger 130 may be sequentially disposed on the second refrigerant line 210 along the flow direction of the refrigerant.

The third refrigerant circuit 300 may include a third refrigerant line 310 along which the refrigerant circulates, and may include a third compressor 320, a fourth heat-exchanger 330, a third expansion valve 340, and a fifth heat-exchanger 350 sequentially disposed on the third refrigerant line 310. The third compressor 320, the fourth heat-exchanger 330, the third expansion valve 340, and the fifth heat-exchanger 350 may be sequentially disposed on the third refrigerant line 310 along the flow direction of the refrigerant.

The first coolant circuit 400 may include a first coolant line 410 along which the coolant heat-exchanged with the refrigerant circulating the second refrigerant circuit 200 circulates, and a plurality of hydrogen compression tanks 600 disposed on the first coolant line 410, and the first coolant line 410 may be provided in a multiple quantity (an eleventh coolant line 411, a twelfth coolant line 412, a thirteenth coolant line 413, and a fourteenth coolant line 414), and each hydrogen compression tank 600 may be disposed on each first coolant line 410. The first coolant line 410 may be a bi-directional pipe through which the coolant can flow bi-directionally.

The second coolant circuit 500 may include a second coolant line 510 along which the coolant heat-exchanged with the refrigerant circulating the third refrigerant circuit 300 circulates, and the plurality of hydrogen compression tanks 600 disposed on the second coolant line 510. The second coolant line 510 may be provided in a multiple quantity (a twenty-first coolant line 511, a twenty-second coolant line 512, a twenty-third coolant line 513, and a twenty-fourth coolant line 514), and each hydrogen compression tank 600 may be disposed on each second coolant line 510. The second coolant line 510 may be a bi-directional pipe through which the coolant can flow bi-directionally.

In an exemplary embodiment of the present disclosure, the first coolant line 410 and the second coolant line 510 may be provided in 4 items each (e.g., eleventh to fourteenth coolant lines 414, and twenty-first to twenty-fourth coolant lines 514), and four hydrogen compression tanks 600 may be provided at locations where the first coolant line 410 and the second coolant line 510 join, respectively. The number of the first coolant line 410, the second coolant line 510, and the hydrogen compression tank 600 may be changed as needed, and the scope of the present disclosure is not limited thereto.

The metal hydride (MH) may be stored inside the hydrogen compression tank 600. The metal hydride stored in the hydrogen compression tank 600 may store and compress the hydrogen gas depending on the temperature change of the coolant circulating the coolant line (the first coolant line 410 and the second coolant line 510).

As described above, when a metal is cooled by a cold coolant, hydrogen molecules may be adsorbed on the metal, and accordingly, the hydrogen gas may be stored in the hydrogen compression tank 600. To the contrary, when the metal hydride is heated by the hot coolant, hydrogen molecules adsorbed on the metal may be desorbed, and accordingly, the hydrogen gas may be compressed in the hydrogen compression tank 600.

Referring to FIG. 3, the hydrogen compression tank 600 may include a tank body 610 storing metal hydride, a coolant inlet line 620 for introducing the coolant into the tank body 610, a coolant discharge line 630 for discharging the coolant received through the coolant inlet line 620 and having circulated the tank body 610, a hydrogen inlet line 640 for supplying the hydrogen gas to the tank body 610, and a hydrogen discharge line 650 for discharging the hydrogen gas generated at the tank body 610.

The hydrogen compression tank 600 may further include a tank valve 680 disposed on the tank body 610 and configured to selectively open or close the first coolant line 410 and the second coolant line 510. Depending on an operation of the tank valve 680, the coolant circulating the first coolant line 410 may circulate the tank body 610, or the coolant circulating the second coolant line 510 may circulate the tank body 610. That is, depending on the operation of the tank valve 680, the coolant inlet line 620 and the coolant discharge line 630 may be selectively and fluidically connected to the first coolant line 410, or the coolant inlet line 620 and the coolant discharge line 630 may be selectively and fluidically connected to the second coolant line 510.

A first hydrogen valve 660 may be disposed on the hydrogen inlet line 640, and depending on the opening and closing of the first hydrogen valve 660, the hydrogen gas may be selectively supplied to the tank body 610. When the first hydrogen valve 660 is opened, the hydrogen gas may be introduced into the tank body 610, and when the first hydrogen valve 660 is blocked, the hydrogen gas is not introduced into the tank body 610.

A second hydrogen valve 670 may be disposed on the hydrogen discharge line 650, and depending on the opening and closing of the second hydrogen valve 670, the hydrogen gas generated at the tank body 610 may be selectively discharged. When the second hydrogen valve 670 is opened, the hydrogen gas generated inside the tank body 610 may be discharged to the outside of the tank body 610, and when the second hydrogen valve 670 is blocked, the hydrogen gas generated inside the tank body 610 is not discharged to the outside of the tank body 610.

As described above, the metal hydride (MH) may be accommodated inside the tank body 610.

Depending on the operation of a cooling valve, the tank body 610 may be cooled by the cold coolant, and when the hydrogen gas is supplied to the tank body 610 through the hydrogen inlet line 640, hydrogen molecules may be adsorbed on the metal. Accordingly, the hydrogen gas may be stored inside the tank body 610.

To the contrary, depending on the operation of the cooling valve, when the tank body 610 is heated by the hot coolant, hydrogen molecules may be desorbed from the metal hydride, and the hydrogen gas may be compressed inside the tank body 610.

Referring back to FIG. 2, the first compressor 120 disposed in the first refrigerant circuit 100 may compress a gaseous refrigerant into a high-temperature and high-pressure gaseous refrigerant.

The first heat-exchanger 130 may heat-exchange the refrigerant circulating the first refrigerant line 110 and the refrigerant circulating the second refrigerant line 210, and the refrigerant compressed by the first compressor 120 may be condensed into a liquid state. That is, the first heat-exchanger 130 may condense the refrigerant supplied from the first compressor 120 through heat-exchange with the refrigerant supplied through the second refrigerant line 210. In the instant case, in the first refrigerant circuit 100, the first heat-exchanger 130 may perform the function of a condenser.

The first expansion valve 140 may expand the refrigerant condensed by the first heat-exchanger 130, and the pressure of the refrigerant is decreased from a high pressure to a low pressure.

The second heat-exchanger 150 may vaporize the low-pressure refrigerant having passed through the first expansion valve 140. Accordingly, the refrigerant in the liquid state may be phase-changed to a gaseous refrigerant. In the first refrigerant circuit 100, the second heat-exchanger 150 may perform the function of an evaporator. At the instant time, the first refrigerant circuit may further include a sixth heat-exchanger 160 configured to heat-exchange the heat absorbed by the refrigerant while being vaporized at the second heat-exchanger with the external air. That is, the second heat-exchanger may vaporize the refrigerant by absorbing the ambient air heat through the sixth heat-exchanger 160.

The second compressor 220 disposed in the second refrigerant circuit 200 may compress a gaseous refrigerant into a high-temperature and high-pressure gaseous refrigerant.

The third heat-exchanger 230 may heat-exchange the coolant circulating the first coolant line 410 and the refrigerant circulating the second refrigerant line 210, and the refrigerant compressed by the second compressor 220 may be condensed into a liquid state in the third heat-exchanger 230. Furthermore, as the coolant circulating the first coolant line 410 undergoes heat transfer with the hot refrigerant at the third heat-exchanger 230, the temperature of the coolant is increased. In the instant case, in the second refrigerant circuit 200, the third heat-exchanger 230 may perform the function of a condenser.

The second expansion valve 240 may expand the refrigerant condensed by the third heat-exchanger 230, and the pressure of the refrigerant is decreased from a high pressure to a low pressure.

The first heat-exchanger 130 may heat-exchange the refrigerant circulating the second refrigerant line 210 and the refrigerant circulating the first refrigerant line 110, and may vaporize the low-pressure refrigerant including passed through the second expansion valve 240. In the instant case, in the second refrigerant circuit 200, the first heat-exchanger 130 may perform the function of an evaporator.

In an exemplary embodiment of the present disclosure, the first refrigerant circuit 100 and the second refrigerant circuit 200 may perform the function of a heating device for heating the coolant flowing through the first coolant line 410.

The third compressor 320 disposed in the third refrigerant circuit 300 may compress a gaseous refrigerant into a high-temperature and high-pressure gaseous refrigerant.

The fourth heat-exchanger 330 may condense the refrigerant compressed by the third compressor 320. At the instant time, the third refrigerant circuit 300 may further include a seventh heat-exchanger 360 configured to heat-exchange the heat generated while the refrigerant is condensed at the fourth heat-exchanger 330 with the external air. That is, the heat generated while the refrigerant is condensed at the fourth heat-exchanger 330 may be discharged to the outside through the seventh heat-exchanger 360.

The third expansion valve 340 may expand the refrigerant condensed by the fourth heat-exchanger 330, and the pressure of the refrigerant is decreased from a high pressure to a low pressure.

The fifth heat-exchanger 350 may heat-exchange the refrigerant circulating the third refrigerant line 310 and the coolant circulating the second coolant line 510, and may vaporize the low-pressure refrigerant having passed through the third expansion valve 340. In the instant case, in the third refrigerant circuit 300, the fifth heat-exchanger 350 may perform the function of an evaporator.

The coolant circulating the second coolant line 510 may be heat-exchanged with the refrigerant at the fifth heat-exchanger 350, and the temperature of the coolant may be lowered. In an exemplary embodiment of the present disclosure, the third refrigerant circuit 300 may perform the function of a cooling apparatus for cooling the coolant flowing through the second coolant line 510.

Hereinafter, operation of a hydrogen supply system according to an exemplary embodiment of the present disclosure will be described in detail with reference to the drawings.

A hydrogen supply system according to an exemplary embodiment of the present disclosure may operate in one mode among a cooling mode for cooling the metal of the hydrogen compression tank 600, an adsorption mode for adsorbing the hydrogen gas on the metal in the hydrogen compression tank 600, a heating mode (or, compression mode) for heating the metal hydride in the hydrogen compression tank 600, and a discharge mode for discharging the hydrogen gas compressed at the hydrogen compression tank 600, depending on the operation of the first hydrogen valve 660, the second hydrogen valve 670, and the tank valve 680.

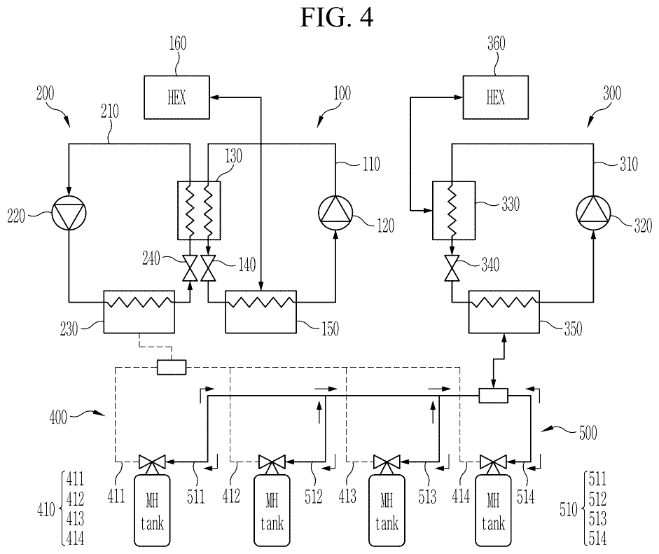

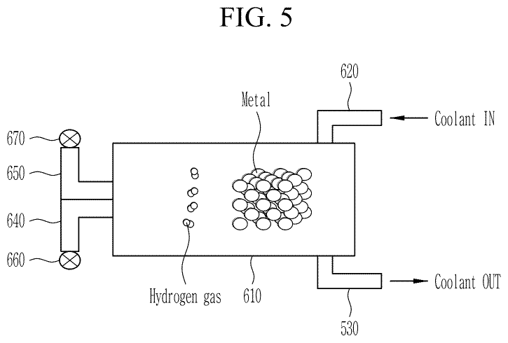

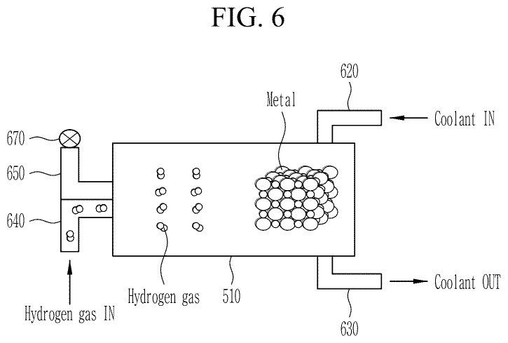

The cooling mode will be described in detail with reference to FIG. 4 and FIG. 5. The cooling mode may be a mode for cooling the metal stored inside the hydrogen compression tank 600.

Referring to FIG. 4 and FIG. 5, in the cooling mode, the tank valve 680 may block the first coolant line 410 and open the second coolant line 510 so that the coolant circulating the second coolant line 510 cools the hydrogen compression tank 600. Furthermore, the first hydrogen valve 660 and the second hydrogen valve 670 may be blocked.

As the tank valve 680 blocks the first coolant line 410 and opens the second coolant line 510, the cold refrigerant circulating the third refrigerant circuit 300 and the coolant circulating the second coolant circuit 500 may be heat-exchanged in the fifth heat-exchanger 350, so that the temperature of the coolant circulating the second coolant circuit 500 is lowered.

The cooled coolant may cool the hydrogen compression tank 600 through the second coolant line 510, and the metal stored inside the tank body 610 may be cooled.

At the present time, as the first hydrogen valve 660 and the second hydrogen valve 670 are blocked, the hydrogen gas is not introduced into the hydrogen compression tank 600.

Furthermore, the high-temperature refrigerant circulating the second refrigerant circuit 200 and the coolant circulating the first coolant circuit 400 may be heat-exchanged in the third heat-exchanger 230, so that the temperature of the coolant circulating the first coolant circuit 400 is increased. At the instant time, as the tank valve 680 blocks the first coolant circuit 400, the high-temperature coolant circulating the first coolant circuit 400 is not introduced into the hydrogen compression tank 600.

The adsorption mode will be described in detail with reference to FIG. 4 and FIG. 6. The adsorption mode may be a mode for adsorbing the hydrogen gas onto the metal inside the hydrogen compression tank 600 and storing the adsorbed hydrogen gas.

Referring to FIG. 4 and FIG. 6, the operation of the tank valve 680 in the adsorption mode is the same as the cooling mode. However, in the adsorption mode, the first hydrogen valve 660 may be opened, and the second hydrogen valve 670 may be blocked.

In the adsorption mode, the tank valve 680 may block the first coolant line 410 and open the second coolant line 510 so that the coolant circulating the second coolant line 510 cools the hydrogen compression tank 600. Furthermore, the first hydrogen valve 660 may be opened, and the second hydrogen valve 670 may be blocked.

As the tank valve 680 blocks the first coolant line 410 and opens the second coolant line 510, the cold refrigerant circulating the third refrigerant circuit 300 and the coolant circulating the second coolant circuit 500 may be heat-exchanged in the fifth heat-exchanger 350, so that the temperature of the coolant circulating the second coolant circuit 500 is lowered.

The cooled coolant may cool the hydrogen compression tank 600 through the second coolant line 510, and the metal stored inside the tank body 610 may be cooled.

At the present time, as the first hydrogen valve 660 is opened, the hydrogen gas may be introduced into the tank body 610 through the hydrogen inlet line 640.

The hydrogen gas introduced into the tank body 610 may be adsorbed on the cooled metal, and the hydrogen gas may be stored inside the tank body 610.

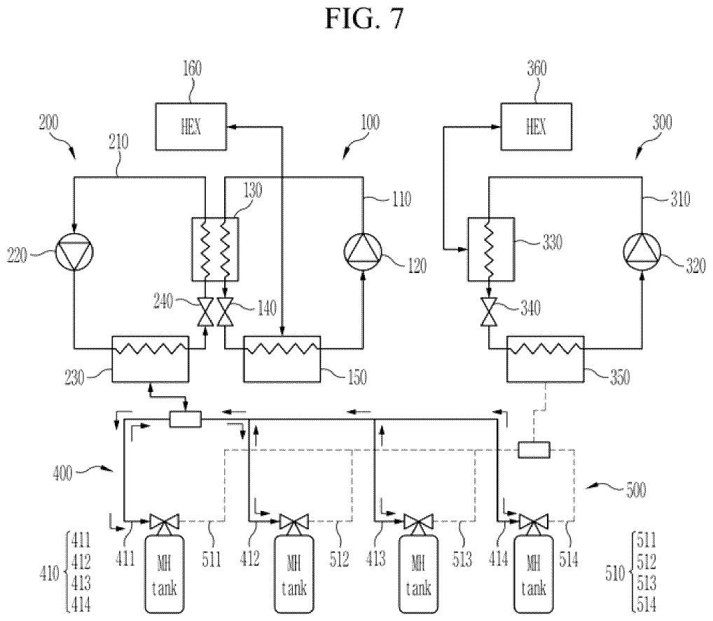

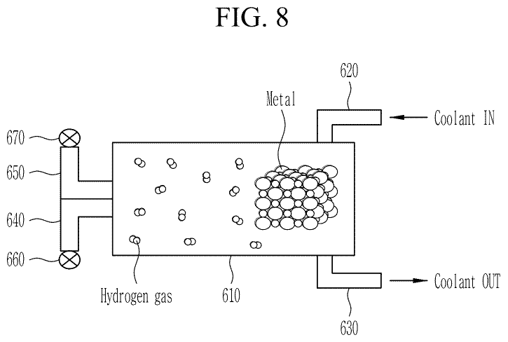

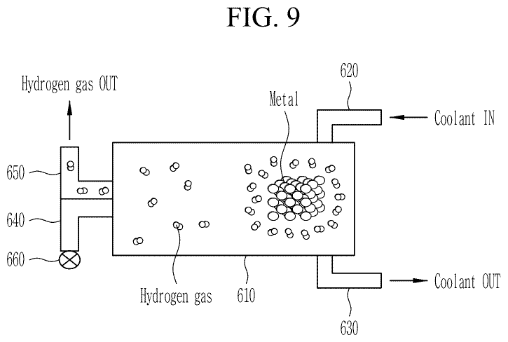

The heating mode will be described in detail with reference to FIG. 7 and FIG. 8. The heating mode may be a compression mode for compressing the hydrogen gas inside the tank body 610.

Referring to FIG. 7 and FIG. 8, in the heating mode, the tank valve 680 may open the first coolant line 410 and block the second coolant line 510 so that the coolant circulating the first coolant line 410 heats the hydrogen compression tank 600. Furthermore, the first hydrogen valve 660 and the second hydrogen valve 670 may be blocked.

As the tank valve 680 opens the first coolant line 410 and blocks the second coolant line 510, the hot refrigerant circulating the second refrigerant circuit 200 and the coolant circulating the second coolant circuit 500 may be heat-exchanged in the third heat-exchanger 230, so that the temperature of the coolant circulating the second coolant circuit 500 is increased.

The high-temperature coolant may heat the hydrogen compression tank 600 through the first coolant line 410, and the hydrogen gas and the metal hydride stored inside the tank body 610 may be heated.

At the present time, since the first hydrogen valve 660 and the second hydrogen valve 670 are blocked, the pressure of the hydrogen gas and the metal hydride inside the hydrogen compression tank 600 may gradually increase.

Furthermore, the cold refrigerant circulating the third refrigerant circuit 300 and the coolant circulating the second coolant circuit 500 may be heat-exchanged in the fifth heat-exchanger 350, so that the temperature of the coolant circulating the second coolant circuit 500 is lowered. At the instant time, as the tank valve 680 blocks the second coolant line 510, the low-temperature coolant circulating the second coolant circuit 500 is not introduced into the hydrogen compression tank 600.

The discharge mode will be described in detail with reference to FIG. 7 and FIG. 9. The discharge mode may be a mode in which the hydrogen gas compressed inside the tank body 610 is discharged.

Referring to FIG. 7 and FIG. 9, in the discharge mode, the operation of the tank valve 680 is the same as the heating mode. However, in the discharge mode, the first hydrogen valve 660 may be blocked, and the second hydrogen valve 670 may be opened.

As the tank valve 680 opens the first coolant line 410 and blocks the second coolant line 510, the hot refrigerant circulating the second refrigerant circuit 200 and the coolant circulating the first coolant circuit 400 may be heat-exchanged in the third heat-exchanger 230, so that the temperature of the coolant circulating the first coolant circuit 400 is increased.

The high-temperature coolant may heat the hydrogen compression tank 600 through the first coolant line 410, and the hydrogen gas and the metal hydride stored inside the tank body 610 may be heated.

At the present time, when the pressure inside the tank body 610 sufficiently increases due to heating of the hydrogen compression tank 600, the second hydrogen valve 670 may be opened, and the hydrogen gas compressed inside the tank body 610 may be discharged to the outside through the hydrogen discharge line 650. Furthermore, the hydrogen that was forming the metal hydride is also desorbed and discharged to the outside through the hydrogen discharge line 650.

Furthermore, the cold refrigerant circulating the third refrigerant circuit 300 and the coolant circulating the second coolant circuit 500 may be heat-exchanged in the fifth heat-exchanger 350, so that the temperature of the coolant circulating the second coolant circuit 500 is lowered. At the instant time, as the tank valve 680 blocks the second coolant line 510, the low-temperature coolant circulating the second coolant circuit 500 is not introduced into the hydrogen compression tank 600.

According to a hydrogen supply system according to an exemplary embodiment of the present disclosure, by storing and compressing the hydrogen gas depending on the temperature change of the metal and the metal hydride, the consumption of electrical energy may be minimized, and the maintenance cost may be reduced.

Furthermore, since the first refrigerant circuit 100 and the second refrigerant circuit 200 is configured as a heating device for heating the coolant circulating the first coolant circuit 400 and the third refrigerant circuit 300 is configured as a cooling apparatus for cooling the coolant circulating the second coolant circuit 500, the control of the hydrogen compression tank 600 may become easier.

Although the exemplary embodiment of the present disclosure has been described, the present disclosure is not limited thereto, and it is possible to carry out various modifications within the scope of the claims, the detailed description of the disclosure, and the accompanying drawings, and the modifications belong to the scope of the present disclosure as a matter of course.

### DESCRIPTION OF SYMBOLS

100: first refrigerant circuit
110: first refrigerant line
120: first compressor
130: first heat-exchanger
140: first expansion valve
150: second heat-exchanger
160: sixth heat-exchanger
200: second refrigerant circuit
210: second refrigerant line
220: second compressor
230: third heat-exchanger
240: second expansion valve
300: third refrigerant circuit
310: third refrigerant line
320: third compressor
330: fourth heat-exchanger
340: third expansion valve
350: fifth heat-exchanger
360: seventh heat-exchanger
400: first coolant circuit
410: first coolant line
411: eleventh coolant line
412: twelfth coolant line
413: thirteenth coolant line
414: fourteenth coolant line
500: second coolant circuit
510: second coolant line
511: twenty-first coolant line
512: twenty-second coolant line
513: twenty-third coolant line
514: twenty-fourth coolant line
600: hydrogen compression tank
610: tank body
620: coolant inlet line
630: coolant discharge line
640: hydrogen inlet line
650: hydrogen discharge line
660: first hydrogen valve
670: second hydrogen valve
680: tank valve

What is claimed is:

1. A hydrogen supply system, comprising:
a first refrigerant circuit comprising a first compressor, a first heat-exchanger, a first expansion valve, and a second heat-exchanger sequentially disposed on a first refrigerant line along which a refrigerant circulates;
a second refrigerant circuit comprising a second compressor, a third heat-exchanger, a second expansion valve, and the first heat-exchanger sequentially disposed on a second refrigerant line along which a refrigerant circulates;
a third refrigerant circuit comprising a third compressor, a fourth heat-exchanger, a third expansion valve, and a fifth heat-exchanger sequentially disposed on a third refrigerant line along which a refrigerant circulates;
a first coolant circuit comprising a plurality of hydrogen compression tanks disposed on a first coolant line along which a coolant heat-exchanged with the refrigerant circulating the second refrigerant circuit circulates; and
a second coolant circuit comprising the plurality of hydrogen compression tanks disposed on a second coolant line along which the coolant heat-exchanged with the refrigerant circulating the third refrigerant circuit circulates,
wherein hydrogen gas is stored and compressed through a metal stored in each hydrogen compression tank depending on a temperature change of the coolant circulating the first coolant circuit and the second coolant circuit.

2. The hydrogen supply system of claim 1, wherein the refrigerant circulating the first refrigerant line and the refrigerant circulating the second refrigerant line undergoes heat transfer in the first heat-exchanger.

3. The hydrogen supply system of claim 1,
wherein the first coolant circuit comprises a plurality of first coolant lines, and
wherein the coolant circulating the first coolant line undergoes heat transfer with the refrigerant circulating the second refrigerant line in the third heat-exchanger.

4. The hydrogen supply system of claim 1,
wherein the second coolant circuit comprises a plurality of second coolant lines, and
wherein the coolant circulating the second coolant line undergoes heat transfer with the refrigerant circulating the third refrigerant line in the fifth heat-exchanger.

5. The hydrogen supply system of claim 1, further comprising a sixth heat-exchanger connected to the second heat-exchanger and configured to heat-exchange a heat absorbed by the refrigerant while being vaporized at the second heat-exchanger with an external air.

6. The hydrogen supply system of claim 1, further comprising a seventh heat-exchanger connected to the fourth heat-exchanger and configured to heat-exchange a heat generated while the refrigerant is condensed at the fourth heat-exchanger with an external air.

7. The hydrogen supply system of claim 6, wherein each hydrogen compression tank comprises:
a tank body accommodating metal hydride;
a coolant inlet line connected to the tank body and selectively and fluidically connected to the first coolant line and the second coolant line;
a coolant discharge line connected to the tank body and selectively and fluidically connected to the first coolant line and the second coolant line;
a hydrogen inlet line connected to the tank body and disposed with a first hydrogen valve to selectively supply the hydrogen gas to the tank body; and
a hydrogen discharge line connected to the tank body and on which a second hydrogen valve is disposed so that the hydrogen gas desorbed from the metal hydride is selectively discharged.

8. The hydrogen supply system of claim 7, further comprising a tank valve disposed on the tank body and configured to selectively open or close the first coolant line and the second coolant line.

9. The hydrogen supply system of claim 8, wherein the tank valve is a three-way valve.

10. The hydrogen supply system of claim 8, wherein, depending on an operation of the first hydrogen valve, the second hydrogen valve, and the tank valve, the hydrogen supply system operates in one mode among:
a cooling mode for cooling the metal of the hydrogen compression tank;
an adsorption mode for adsorbing the hydrogen gas on the metal in the hydrogen compression tank;
a heating mode for heating the metal hydride in the hydrogen compression tank; and
a discharge mode for discharging the hydrogen gas compressed at the hydrogen compression tank.

11. The hydrogen supply system of claim 10, wherein, in the cooling mode,
the tank valve blocks the first coolant line and opens the second coolant line so that the coolant circulating the second coolant line cools the hydrogen compression tank; and
the first hydrogen valve and the second hydrogen valve are blocked.

12. The hydrogen supply system of claim 10, wherein, in the adsorption mode,
the tank valve blocks the first coolant line and opens the second coolant line so that the coolant circulating the second coolant line cools the hydrogen compression tank;
the first hydrogen valve is opened; and
the second hydrogen valve is blocked.

13. The hydrogen supply system of claim 10, wherein, in the heating mode,
the tank valve opens the first coolant line and blocks the second coolant line so that the coolant circulating the first coolant line heats the hydrogen compression tank; and
the first hydrogen valve and the second hydrogen valve are blocked.

14. The hydrogen supply system of claim 10, wherein, in the discharge mode,
the tank valve opens the first coolant line and blocks the second coolant line so that the coolant circulating the first coolant line heats the hydrogen compression tank;
the first hydrogen valve is blocked; and
the second hydrogen valve is opened.
